(19) United States
(12) Patent Application Publication
(10) Pub. No.: US 2010/0307781 A1
(43) Pub. Date: Dec. 9, 2010

(54) COUPLING DEVICE FOR CONNECTING A HEAVY VEHICLE AND A TOWED UNIT, AND TOWING METHOD

(75) Inventor: Dominique Dessevre, Chatel-Guyon (FR)

Correspondence Address: COHEN, PONTANI, LIEBERMAN & PAVANE LLP, 551 FIFTH AVENUE, SUITE 1210, NEW YORK, NY, 10176, US

(73) Assignees: Societe De Technologie Michelin, Clermont-Ferrand (FR); Michelin Recherche et Technique S.A., Granges-Paccot (CH)

(21) Appl. No.: 12/669,713

(22) PCT Filed: Jul. 9, 2008
(86) PCT No.: PCT/EP2008/058938

§ 371 Date: Jun. 14, 2010

(30) Foreign Application Priority Data
Jul. 16, 2007 (FR) 07/05167

(51) Int. Cl. A01B 59/04; B60D 1/24

(52) U.S. Cl. 172/677; 280/492

(57) ABSTRACT

A device providing a connection between a heavy vehicle and towed machinery which are arranged in a working position on ground forming a horizontal plane, the device allowing the movement of relative pitching between the towed machinery and the heavy vehicle. The distance between the instantaneous centre of rotation of the relative pitching movement of the towed machinery with respect to the heavy vehicle and the orthogonal projection of the instantaneous centre of rotation onto the horizontal plane is less than 1/9 of the outside diameter of the largest mounted assembly of the heavy vehicle and/or than 25 centimetres. Also disclosed is a method for towing machinery using a heavy vehicle.

The present invention relates to a device providing a connection between a heavy vehicle such as an agricultural tractor and towed machinery such as an implement for working the soil. The invention also relates to a method for towing machinery using a heavy vehicle.

It has been apparent that, under certain driving conditions, as soon as the towed machinery begins to exert a non-negligible force resisting forward travel, for example under the effect of an element such as a disc penetrating the ground, the tractor hops and bounces around causing first of all problems of comfort for the driver, and thus making the driver's work increasingly arduous, and sometimes going so far as to cause problems with getting the tractor to advance, as the periods of contact become insufficient to allow the friction needed to gain forward propulsion of the tractor on the ground, thus causing the said tractor to lose efficiency by impairing the grip of the tire on the ground concerned.

This bouncing and hopping around is characterized by intermittent or almost-sustained oscillations of the driving combination at low frequencies usually comprised between 0.5 and 4 Hz and known by the name of “power hop”.

The solutions currently employed by users involve adapting the tractor tire inflation pressure empirically or using step-by-step methods proposed by the vehicle manufacturers or the tire makers. These adjustments to the pressure or to the ballasting of the tractor on the one hand cause the user to lose time and also detract from the performance of the vehicle because the optimum recommended settings are no longer adhered to. Excessively high pressures may, for example, lead to greater compaction of loose ground and greater resistance to forward travel.

The extensive research carried out by the applicant company into modifying the tires, particularly the meridian profiles of the tread, the meridian profiles of the carcass reinforcement, the materials of the carcass and crown reinforcements, and modifications to the designs and dimensions of the tread blocks have not, as yet, brought the expected improvements because these modifications have little or no influence on the hopping phenomenon described hereinabove.

Regarding the conventional design of tires for agricultural machinery, the carcass reinforcement, anchored in each bead, is made up of at least one layer of textile and/or metal reinforcing elements, the said elements being substantially mutually parallel within the layer and being able to be substantially radial and/or distinctly crossed from one layer to the next, making equal or unequal angles with the circumferential direction. The carcass reinforcement is usually surmounted by a crown reinforcement made up of at least two working crown layers of reinforcing elements which may be textile or metal, but which cross from one layer to the next, making small angles with the circumferential direction. The tread of the tire in question is made up of rubber blocks or strips, that are inclined with respect to the circumferential direction by generally a high angle, and are generally circumferentially spaced apart by hollows which (measured in the circumferential direction) are wider than the mean width of the strips. The said strips may be symmetric with one another with respect to the equatorial plane, being axially continuous or, as in most cases, axially discontinuous. The ends of axial strips near the equatorial plane are then, in most cases, circumferentially offset from one another, exhibiting what is commonly known as a chevron pattern.

In patent FR 1 046 427, the applicant company for example described carcass reinforcements in which the directions of the reinforcing elements of the ply or plies in one sidewall are substantially symmetric, with respect to the equatorial plane of the tire, with the directions of the reinforcing elements of the said ply (plies) in the other sidewall. As disclosed and explained, a ply is to be understood to be either a ply that is axially continuous from bead to bead, or two half-plies anchored in each bead to an annular bead reinforcing element but the radically upper ends of which are distant from one another and from the equatorial plane.

U.S. Pat. No. 3,108,628 again teaches, with a view to giving the tire good stability under transverse load, supplementing the radial carcass reinforcement with so-called stabilizing half-plies made up of reinforcing elements that are inclined with respect to the circumferential direction, the said half-plies overlapping at the crown over most of the axial width of the tread so that the reinforcing elements cross one another.

Patent FR 1 259 199 also discloses and describes a one-way carcass reinforcement made up of two half-plies of reinforcing elements inclined with respect to the circumferential direction in such a way that they overlap in the crown of the tire to form a crossed reinforcement.

Other documents describe solutions that are not tire-related but are connected with the vehicle and/or with the towed implement in an attempt to alleviate this problem of hopping around.

Document U.S. Pat. No. 6,260,873 describes a device interposed between a tractor and a towed implement in order to absorb the tensions that may arise between the tractor and the implement.

Document US 20050269796 describes an optimized suspension system for an agricultural tractor enabling this phenomenon of power hop to be limited.

In their studies, the inventors therefore set themselves the task of improving the behaviour of tractor and towed machinery combinations and in particular of culminating in combinations in which the tractor bounces, hops or “power hops” around little if at all, and which are characterized by almost-sustained oscillations of the running combination at low frequencies comprised between 0.5 and 4 Hz.

This object has been achieved according to the invention using a device providing a connection between a heavy vehicle comprising at least two mounted assemblies and towed machinery which are arranged in a working position on ground forming a horizontal plane, the said device allowing the movement of relative pitching between the towed machinery and the heavy vehicle, the distance between the instantaneous centre of rotation of the relative pitching movement of the towed machinery with respect to the heavy vehicle and the orthogonal projection of the said instantaneous centre of rotation onto the said horizontal plane being less than 1/9 of the outside diameter of the largest mounted assembly (assemblies) of the heavy vehicle.

Within the meaning of the invention, a mounted assembly consists of a wheel and of a tire.

The outside diameter of a mounted assembly is measured under nominal inflation pressure conditions, with the said mounted assembly being unloaded.

This object has been achieved according to the invention in the same way using a device providing a connection between a heavy vehicle and towed machinery which are arranged in a working position on ground forming a horizontal plane, the said device allowing the movement of relative pitching between the towed machinery and the heavy vehicle, the distance between the instantaneous centre of rotation of the relative pitching movement of the towed machinery with respect to the heavy vehicle and the orthogonal projection of the said instantaneous centre of rotation onto the said horizontal plane being less than 25 centimetres.

Within the meaning of the invention, ground that forms a horizontal plane is firm ground, which means that the heavy vehicle does not create any ruts in the said plane when the distance concerned is being measured.

Again within the meaning of the invention, the working position corresponds to the heavy vehicle, the towed machinery and the connecting device being installed in such a way that the towed machinery is in its operational position.

Tests carried out with a device as defined have shown that the bouncing or hopping around that usually occurs at low frequencies is far more rare in its occurrence, or even completely non-existent, or at the very least is less pronounced in terms of the amplitude of the hops.

According to a first embodiment of the invention, the connecting device is an element interposed between the heavy vehicle and the towed machinery.

According to this first embodiment, it is possible to fit the connecting device to existing vehicles and towed machinery, the device being designed to supplement the usual hitching systems for this type of vehicle and machinery, the said connecting device being interposed between the existing hitching systems. It is thus possible to fit a device according to the invention to existing vehicles and towed machinery without having to reassess the design thereof, and therefore combat this bouncing or hopping around on equipment that has already been acquired.

The connecting device is therefore advantageously made up of a single element that is articulated, in order to allow at least the movement of relative pitching of the towed machinery with respect to the heavy vehicle, which can be fixed at each of its ends to the vehicle, on the one hand, and the towed machinery, on the other.

According to a second embodiment of the invention, the connecting device consists of two parts secured respectively to the heavy vehicle and to the towed machinery and which can be connected to one another to form an articulated connection, in order to allow at least the movement of relative pitching of the towed machinery with respect to the heavy vehicle.

According to this second embodiment, the connecting device is advantageously provided right from the design stage of the vehicles and of the towed machinery. Installing the connecting device thus becomes transparent to the operator, the said connecting device right from the design phase of the vehicles and machinery taking the place of the currently known hitch systems.

One alternative form of the invention has it that the instantaneous centre of rotation of the relative pitching movement of the towed machinery with respect to the heavy vehicle corresponds to a physical element of the connecting device. The device according to the invention in this alternative form, with the heavy vehicle and towed machinery combination arranged in a working position on ground forming a horizontal plane, comprises an articulation element distant from its orthogonal projection onto the said horizontal plane by less than 1/9 of the outside diameter of the largest mounted assembly of the heavy vehicle and/or by less than 25 centimetres.

This articulation element can then be associated with a protective element protecting against any potential attack which may for example come from any unevenness of or stones on the ground. Specifically, this type of combination made up of a heavy vehicle and of towed machinery is essentially used in a working position on agricultural land which is uneven, potentially constituting a risk to the device according to the invention and particularly to the said articulation point. The articulation element is in fact, according to the invention, at an unaccustomedly small distance from the ground by comparison with known connecting systems. A protective element such as this is, for example, a share which is fixed ahead of the articulation element to prevent any contact between it and the ground. This protective share is then advantageously chosen to have a shape suited to reducing the resistance to forward travel it introduces if it penetrates the ground to a significant extent.

A protective element such as this is of further use when driving in the working position over loose ground because the tires push the ground down by compacting it and the level of the mean driving plane finds itself lowered with respect to the mean plane of the surface of the ground. The articulation element of the device according to the invention may therefore find itself at a distance away from the ground that is less than the distance at which it lies when the heavy vehicle and the towed machinery are running on ground that forms a horizontal plane that is firm enough for the mean driving plane and the plane of the surface of the ground to be considered to coincide.

A protective element such as this may be considered indispensible as soon as driving in the working position on loose ground leads to a distance between the articulation element, or instantaneous centre of rotation of the movement of relative pitching of the towed machinery with respect to the heavy vehicle, and its orthogonal projection onto the mean driving plane which is less than the distance measured, in a direction perpendicular to the mean driving plane, between the mean driving plane and the mean plane of the surface of the ground. The articulation element finding itself below the mean plane of the surface of the ground may therefore be in the ground.

According to another alternative form of embodiment of the invention, the instantaneous centre of rotation of the movement of relative pitching of the towed machinery with respect to the heavy vehicle corresponds to a virtual point.

The point is said to be “virtual” within the meaning of the invention either because there is no physical material or because the material present near the geometric position of the said point plays no part in allowing the rotation of the movement of relative pitching of the towed machinery with respect to the heavy vehicle. A virtual point constituting an instantaneous centre of relative rotation between two parts of a combination in a vertical plane is, for example, obtained by connecting the two parts using two bars such that, for each of the bars, the straight line passing through the points of articulated connection at the end of the bar to each of the parts passes through the virtual point. This alternative form of embodiment will be returned to in greater detail with reference to the description of the figures. Likening the instantaneous centre of rotation of the pitching movement to a virtual point makes it possible, unlike in the preceding alternative form of embodiment of the invention, to prevent any risk of damage due to the proximity of a material part of the device to the surface of the ground on which the heavy vehicle and towed machinery combination is moving, the connecting device according to the invention no longer necessarily having a part that is lowered by comparison with customary connecting systems.

Advantageously according to the invention, the connecting device is designed not to oppose a rotational movement of relative roll between the heavy vehicle and the towed machinery. This is because it is necessary to retain free rotational movement of relative roll in order to allow the heavy vehicle/towed machinery combination to drive over all kinds of terrain. The articulation system or systems, whether in the case of an alternative form comprising an instantaneous centre of rotation for the movement of relative pitching that corresponds to a physical element or alternatively in the case of an instantaneous centre of rotation for the movement of relative pitching that corresponds to a virtual point, are then made up of systems that allow rotational movements in at least two directions.

Advantageously again according to the invention, the connecting device is designed not to oppose a rotational movement of relative turning between the heavy vehicle and the towed machinery, as has to be performed for example at the headland in order to make an about turn. A first alternative form of embodiment of the invention has it that the articulation system or systems consist of systems of the ball joint type or any other equivalent systems allowing relative rotational movements in three directions. Another alternative form of embodiment of the invention has one or more articulation systems allowing relative rotational movements in pitch and in roll, it being possible for the rotational turning movement to be provided either between the connecting device and the heavy vehicle or between the connecting device and the towed machinery.

Advantageously again, particularly in the case of a connecting device according to the invention comprising an instantaneous centre of rotation of the pitching movement that corresponds to a physical element of the connecting device, the said connecting device is associated with a lift system to allow the heavy vehicle/towed machinery combination to run on roads without the said towed machinery being in the working position and indeed without it being able to be in contact with the ground. Advantageously also, such a lift system is connected to the heavy vehicle and at the very least controlled therefrom.

The invention also advantageously provides a safety system associated with the connecting device that allows the connection between the towed machinery and the heavy vehicle to be interrupted particularly if the towed machinery becomes stuck in the working situation, in order to avoid any risk of damage to the connecting device, to the towed machinery and/or to the heavy vehicle. This may be for example a system of the shear pin or stud type as is conventionally found on present-day connecting systems.

The various embodiments and/or alternative forms of embodiment of the invention which have been given hereinabove are more particularly suited to the case of an agricultural tractor towing an implement for working the soil, which gives rise to a great deal of resistance to forward travel, such as a disc cultivator.

The invention further proposes a method of towing machinery using a heavy vehicle comprising at least two mounted assemblies, whereby the distance between the geometric point of application of the pure resistive force exerted by the towed machinery on the heavy vehicle and the orthogonal projection of the said geometric point of application of the pure resistive force exerted by the towed machinery on the heavy vehicle onto a plane substantially parallel to the plane of the surface of the ground and containing the geometric point of application of the pure friction force applied by the ground to the heavy vehicle is less than 1/9 of the outside diameter of the largest mounted assembly of the heavy vehicle.

The invention also proposes a method of towing machinery using a heavy vehicle, whereby the distance between the geometric point of application of the pure resistive force exerted by the towed machinery on the heavy vehicle and the orthogonal projection of the said geometric point of application of the pure resistive force exerted by the towed machinery on the heavy vehicle onto a plane substantially parallel to the plane of the surface of the ground and containing the geometric point of application of the pure friction force applied by the ground to the heavy vehicle is less than 25 centimetres.

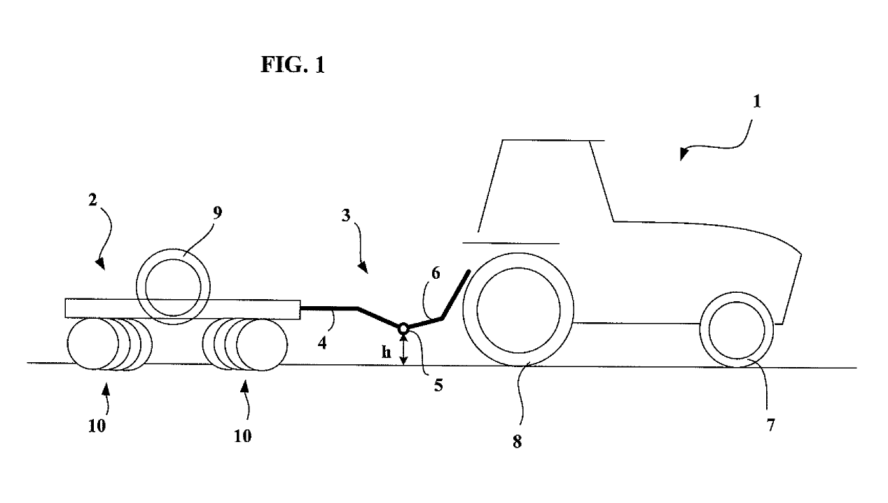

Other details and advantageous features of the invention will become apparent hereinafter from the description of some exemplary embodiments of the invention given with reference to FIGS. 1 to 3 which depict:

FIG. 1: a schematic depiction of a device according to a first embodiment of the invention in the working position;

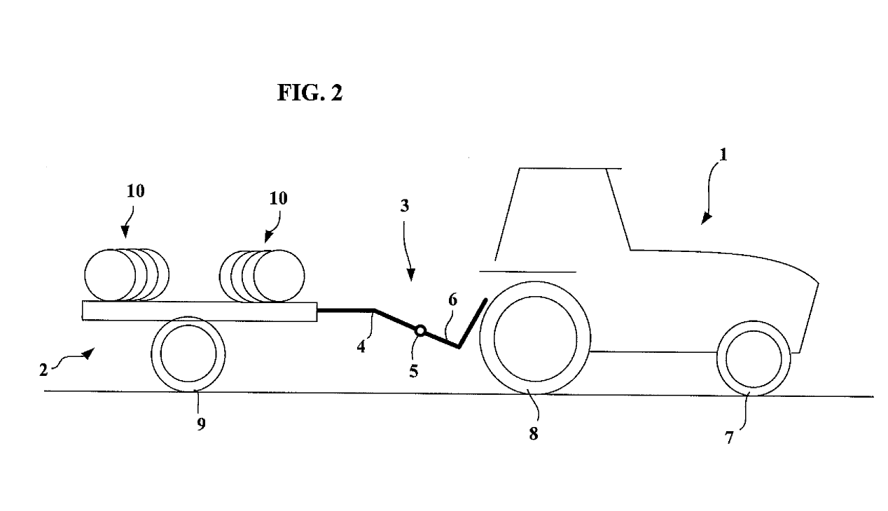

FIG. 2: a schematic depiction of the device of the figure in the transport position;

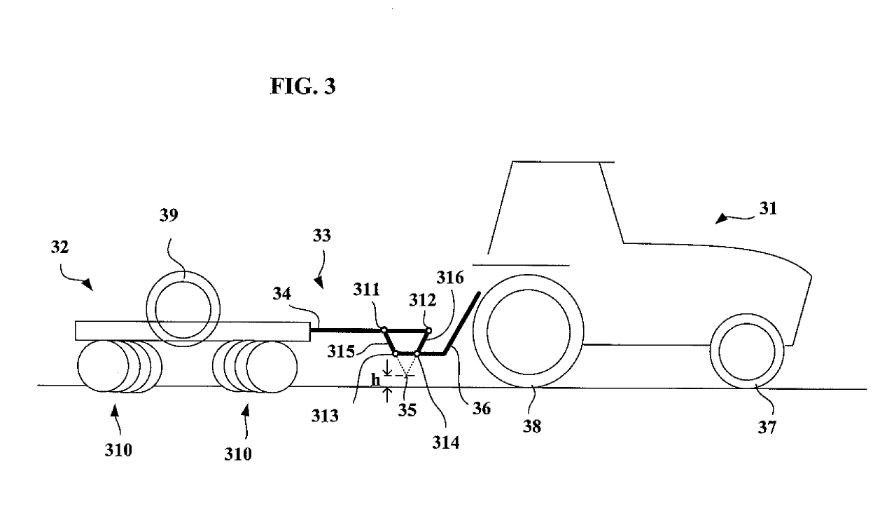

FIG. 3: a schematic depiction of a device according to a second embodiment of the invention.

In order to make them easier to understand, the figures are not drawn to scale.

In FIG. 1, an agricultural tractor 1 is towing stubble ploughing machinery 2, the vehicle and the machinery being connected by a connecting device 3 according to the invention. This connecting device 3 is made up of three parts 4, 5 and 6. The part 4 is secured to the towed machinery 2 and constitutes its connecting link or drawbar. The part 6 constitutes the connecting link connecting to the tractor 1. And the part 5 forms the instantaneous centre of rotation of the movement of relative pitching of the towed machinery 2 with respect to the tractor 1 and the connecting element connecting the parts 4 and 6. This part 5 may be a hitch system similar to those that already exist in the field of agriculture and which allows rotational movements of pitching, rolling and turning.

The rotational movements of pitching and of rolling of the connecting device 3 allow the tractor 1 and towed machinery 2 combination to drive over uneven terrain or ground and thus absorb unevennesses of the terrain without the risk of introducing excessively high stresses into the connecting device 3.

The rotational turning movement of the connecting device 3 is also advantageously designed to allow the tractor 1-towed machinery 2 combination to be manoeuvred particularly in order to follow non-straight paths.

The part 5 may thus be designed to allow freedom in rotation likenable to that allowed by a ball type device.

According to other embodiments of the invention, the rotational turning movement to allow the tractor 1 and towed machinery 2 combination to be manoeuvred may be obtained using a hitch system provided for this purpose between the link 6 of the connecting device 3 and the tractor 1 or alternatively between the link 4 of the connecting device 3 and the towed machinery 2. This rotational turning movement is then obtained via means separate from the part 5 that allows the rotational pitching and rolling movements.

According to the invention, the height h separating the part 5 of the connecting device from a horizontal plane on which the tractor 1 and towed machinery 2 combination is placed in the working position is equal to 10 centimetres. The results obtained during tests carried out have shown that the power hop phenomena that occur with conventional connecting devices occur less frequently and in a less marked way or no longer appear with the connecting device according to the invention.

When driving in the fields, the low height of the part 5 of the connecting device 3 makes this part vulnerable because of the possible presence of obstacles of the stone type or the like in the path followed by this part 5.

The invention advantageously anticipates adding protective elements, not depicted in the figures, associated with the connecting device 3. These may, for example, be a share positioned in front of the part 5, in the direction of forward travel of the tractor, which moves aside any obstacles that may be prejudicial to the integrity of the connecting device 3.

The type of protection is of more particular benefit when the tractor is working on loose terrain because the wheels 7, 8 of the tractor 1 create ruts which reduce the distance between the part 5 and the zone of the ground directly facing it, this part by design lying between the ruts formed by the wheels 7, 8. The risk of contact with obstacles which could damage the connecting device increases because of this even greater proximity of the part 5 of the connecting device 3 to the ground.

FIG. 2 illustrates the same tractor 1, towed machinery 2 and connecting device 3 combination, the said connecting device 3 being in a raised position to allow it to be driven along a path or road without the towed machinery being operational.

The link 6 connected to the tractor 1 is for that reason advantageously designed to be a lifting arm, in a similar way to that which is already in existence on vehicles of this type.

The towed machinery 2 further comprises a conventional turning-over system, not depicted in the figures, which allows it to be set down on its wheels 9 and allows the working elements 10 to be placed in an inactive position as shown in FIG. 2.

FIG. 3 depicts a combination of an agricultural tractor 31 and of towed machinery 32 which are similar to those described in the preceding figures and which are connected by a connecting device 33 corresponding to an alternative form of embodiment of the invention in which the risks of damage due to the proximity of the ground are eliminated.

Whereas in the embodiment depicted in FIGS. 1 and 2, the instantaneous centre of rotation of the pitching movement of the towed machinery with respect to the tractor corresponds to a physical element, the part 5 of the connecting device 3, the instantaneous centre of rotation of the pitching movement of the towed machinery with respect to the tractor corresponds, in the case of FIG. 3, to a virtual point 35 of the connecting device 33.

This virtual point 35 is defined by the presence of a system of four articulations 311, 312, 313, 314 connecting the link 34, secured to the towed machinery, and the link 36, secured to the tractor, by two connecting elements 315, 316, and of which the respective projections into a vertical plane containing the direction of forward travel of the tractor can be likened to straight lines which meet at the virtual point 35.

As in the case of the preceding figures, the system with a virtual instantaneous centre is designed to allow at least rotational pitching and rolling movements of the towed machinery 32 with respect to the tractor 31. Articulations of the ball joint or pivot pin type may also be provided in order also to allow rotations of the turning type.

In FIG. 3, the link 34 of the towed machinery 32 is depicted in a higher position than the link 36 of the tractor 31 but the opposite depiction with a link 36 above the link 34 would be equivalent.

Tests have been carried out using a configuration according to that of FIG. 1 and using an alternative form with a different height h, and the results have been compared against those obtained with a reference standard connection.

In both cases according to the invention and in the reference device, the tractor and the towed machinery were identical and were driving over identical ground. The tractor was an agricultural tractor with four driven wheels of unequal sizes (smaller wheels at the front than at the rear), with a suspended front axle assembly (left free or locked up during the various tests) and the towed machinery was a tine cultivator. The outside diameter of the largest mounted assemblies (at the rear) was 1.95 metres.

The height h of the devices according to the invention is equal to 10 centimetres in the first case and 20 cm in the second case.

The point of attachment of the reference tractor and towed machinery combination was for its part positioned at a height of 45 centimetres from a horizontal plane on which the said tractor and towed machinery combination was placed.

The tests were carried out at various inflation pressures, notably in order to cover the range of inflation pressures observed with farmers and take account of all the situations in which the power hop phenomenon may arise.

The tests were carried out on wheat stubble making one or two passes over the same place in order to reproduce what a farmer actually does, the second pass being aimed at completing the digging-in of undesirable vegetation.

The results revealed that the connecting devices according to the invention were effectively able to limit or even eliminate this power hop phenomenon in some scenarios. Indeed, whatever the running conditions, it became obvious that, by comparison with the reference combination, the combinations of tractor and towed machinery associated with a connecting device according to the invention led to acceptable comfort and traction when the reference combination was either unacceptably uncomfortable for the driver or displayed an unacceptable lack of traction because of the power hop phenomenon.

Furthermore, comparing the results obtained with the two devices according to the invention revealed that under certain running conditions, a height h equal to 10 cm made it possible completely to eliminate the power hop phenomenon or at the very least further improved comfort and traction of the tractor and towed machinery combination by comparison with a height h of 20 cm.

1. A device providing a connection between a heavy vehicle comprising at least two mounted assemblies and towed machinery which are arranged in a working position on ground forming a horizontal plane, the device allowing the movement of relative pitching between the towed machinery and the heavy vehicle, wherein a distance between an instantaneous centre of rotation of the relative pitching movement of the towed machinery with respect to the heavy vehicle and an orthogonal projection of the instantaneous centre of rotation onto the horizontal plane is less than 1/9 of the outside diameter of the largest mounted assembly of the heavy vehicle.

2. A device providing a connection between a heavy vehicle and towed machinery which are arranged in a working position on ground forming a horizontal plane, the device allowing movement of relative pitching between the towed machinery and the heavy vehicle, wherein the distance between an instantaneous centre of rotation of the relative pitching movement of the towed machinery with respect to the heavy vehicle and an orthogonal projection of the said instantaneous centre of rotation onto the horizontal plane is less than 25 centimetres.

3. The device according to claim 1 or 2, wherein the connecting device is an element interposed between the heavy vehicle and the towed machinery.

4. The device according to claim 1 or 2, wherein the connecting device consists of two parts secured respectively to the heavy vehicle and to the towed machinery.

5. The device according to claim 1 or 2 wherein, the instantaneous centre of rotation of the pitching movement corresponds to a physical element of the connecting device.

6. The device according to claim 5, wherein the instantaneous centre of rotation of the pitching movement is associated with a protective element.

7. The device according to claim 1 or 2, wherein the instantaneous centre of rotation of the pitching movement corresponds to a virtual point.

8. The device according to claim 1 or 2, wherein heavy vehicle is an agricultural tractor and wherein the towed equipment is an implement for working the soil.

9. A method of towing machinery using a heavy vehicle comprising at least two mounted assemblies, wherein a distance between a geometric point of application of a pure resistive force exerted by the towed machinery on the heavy vehicle and an orthogonal projection of the geometric point of application of the pure resistive force exerted by the towed machinery on the heavy vehicle onto a plane substantially parallel to the plane of the surface of the ground and containing the geometric point of application of the pure friction force applied by the ground to the heavy vehicle is less than 1/9 of the outside diameter of the largest mounted assembly of the heavy vehicle.

10. A method of towing machinery using a heavy vehicle, wherein a distance between a geometric point of application of the pure resistive force exerted by the towed machinery on the heavy vehicle and an orthogonal projection of the geometric point of application of the pure resistive force exerted by the towed machinery on the heavy vehicle onto a plane substantially parallel to the plane of the surface of the ground and containing the geometric point of application of the pure friction force applied by the ground to the heavy vehicle is less than 25 centimetres.
